(19) United States
(12) Patent Application Publication
(10) Pub. No.: US 2025/0123737 A1
(43) Pub. Date: Apr. 17, 2025

(54) Audio and Video Processing Device and Processing Device

(71) Applicant: Yamaha Corporation, Hamamatsu-shi (JP)

(72) Inventors: Hisashi NAGAI, Hamamatsu-shi (JP); Taku AOYAMA, Hamamatsu-shi (JP); Norio GOSHIMA, Tokyo (JP); Eiichiro KITO, Tokyo (JP)

(21) Appl. No.: 18/990,791

(22) Filed: Dec. 20, 2024

Related U.S. Application Data
(63) Continuation of application No. PCT/JP2022/026179, filed on Jun. 30, 2022.

(51) Int. Cl. G06F 3/04847; G06F 3/041; G06F 3/04817

(52) U.S. Cl. CPC G06F 3/04847; G06F 3/0412; G06F 3/04817

(57) ABSTRACT

A processing device includes: a touch panel that has a display surface that displays an icon related to a processing parameter, and that detects a change in electrostatic capacitance; a physical operator that is arranged on the display surface, and that changes the electrostatic capacitance detected by the touch panel in response to being operated by a user; a processor that changes the processing parameter in response to a change in the electrostatic capacitance based on the operation of the physical operator, and, in response to an input to the touch panel accompanying a change in the electrostatic capacitance via an operation of the physical operator, select a type of processing parameter and an icon corresponding to the processing parameter. The physical operator receives a user operation corresponding to the processing parameter selected by the processor.

### CROSS-REFERENCE TO RELATED APPLICATIONS

The present application is a continuation application of International Application No. PCT/JP2022/026179, filed Jun. 30, 2022, the contents of which are incorporated herein by reference.

### TECHNICAL FIELD

The present disclosure relates to an audio and video processing device, and a processing device.

### BACKGROUND

In Japanese Unexamined Patent Application, First Publication No. 2021-069028, a digital mixer including a plurality of physical operators (for example, push switches, encoders, and faders) is disclosed. In a digital mixer having physical operators, a user is capable of recognizing where the finger is touching as a result of touching the physical operators with the finger without looking at the digital mixer. That is to say, usability (ease of use) is ensured in a digital mixer having physical operators.

### SUMMARY

However, in conventional processing devices such as the digital mixer of Japanese Publication No. 2021-069028, discussed above, each physical operator is only provided with a single type of function. For example, when a physical operator is a push switch, only a pushing function of the push switch is provided. For this reason, the number of physical operators in the processing device increases, and as a result, there is a limit to how much the size and cost of the processing device can be reduced.

The present disclosure has been made in view of the circumstances described above, and an object thereof is to provide an audio and video processing device and a processing device that are capable of achieving a reduction in size and cost, while ensuring usability.

A first aspect of the present disclosure is an audio and video processing device including: a channel to which a signal related to at least one of audio and video is input; a control unit that changes a processing parameter corresponding to the signal that has been input to the channel; a touch panel that has a display surface that displays an icon corresponding to the channel and related to the processing parameter, and that detects a change in electrostatic capacitance accompanying a user operation; a physical operator that is arranged on the display surface, and that changes the electrostatic capacitance detected by the touch panel in response to being operated by a user; and a function selection unit that, in response to an input to the touch panel accompanying a change in the electrostatic capacitance via the operation of the physical operator, selects a type of processing parameter and the icon corresponding to the processing parameter, wherein the control unit changes the processing parameter in accordance with the change in the electrostatic capacitance based on the operation of the physical operator, and wherein the physical operator receives a user operation corresponding to the processing parameter selected by the function selection unit.

A second aspect of the present disclosure is a processing device including: a touch panel that has a display surface that displays an icon related to a processing parameter, and that detects a change in electrostatic capacitance; a physical operator that is arranged on the display surface, and that changes the electrostatic capacitance detected by the touch panel in response to being operated by a user; a control unit that changes the processing parameter in response to a change in the electrostatic capacitance based on the operation of the physical operator; and a function selection unit that, in response to an input to the touch panel accompanying a change in the electrostatic capacitance via an operation of the physical operator, selects a type of processing parameter and an icon corresponding to the processing parameter, wherein the physical operator receives a user operation corresponding to the processing parameter selected by the function selection unit.

### BRIEF DESCRIPTION OF DRAWINGS

FIG. 1 is a front view showing a processing device according to an embodiment of the present disclosure.

FIG. 2 is a cross-sectional view showing a push switch in FIG. 1.

FIG. 3 is a cross-sectional view showing a first encoder in FIG. 1.

FIG. 4 is a block diagram showing an example of a hardware configuration of the processing device shown in FIG. 1.

FIG. 5 is a diagram showing a functional configuration of the signal processing executed in the DSP in FIG. 4.

FIG. 6 is a diagram showing the configuration of the input channels in FIG. 5 in more detail.

FIG. 7 is a diagram showing the configuration of the output channels in FIG. 5 in more detail.

FIG. 8 is a diagram showing the configuration of the cue output channel shown in FIG. 5 in more detail.

FIG. 9 is a diagram showing a first display example of the display surface of the processing device in FIG. 1.

FIG. 10 is a diagram showing a second display example of the display surface of the processing device in FIG. 1.

FIG. 11 is a diagram describing a change in the display of an icon corresponding to a motion of the push switch in FIGS. 1 and 2.

FIG. 12 is a diagram describing a change in the display of an icon corresponding to a motion of the push switch in FIGS. 1 and 2.

FIG. 13 is a diagram describing a change in the display of an icon corresponding to a motion of the push switch in FIGS. 1 and 2.

FIG. 14 is a diagram describing a change in the display of an icon corresponding to a motion of the push switch in FIGS. 1 and 2.

FIG. 15 is a diagram describing a change in the display of an icon corresponding to a motion of the push switch in FIGS. 1 and 2.

FIG. 16 is a front view showing main parts of a fader provided in a processing device according to another embodiment of the present disclosure.

FIG. 17 is a cross-sectional view along line XVII-XVII in FIG. 16.

### DETAILED DESCRIPTION

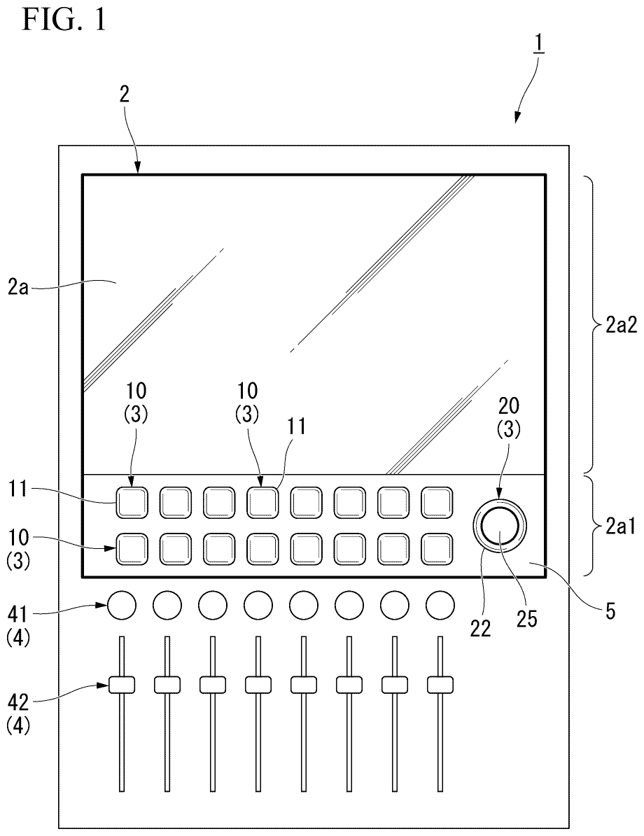

Hereunder, an embodiment of the present disclosure will be described with reference to FIGS. 1 to 15.

The processing device of the present embodiment is an audio processing device that executes signal processing with respect to an input audio signal (an audio-related signal), and then outputs the signal to the outside. As shown in FIG. 1, the processing device 1 includes a touch panel 2, and a plurality of physical operators 3 and 4.

The touch panel 2 has a display surface 2a that displays various information. The touch panel 2 detects a change in electrostatic capacitance accompanying a user operation. The electrostatic capacitance detected by the touch panel 2 is the electrostatic capacitance between the display surface 2a of the touch panel 2 and a user's finger. In the touch panel 2, the detected electrostatic capacitance changes as a result of a user's finger approaching the display surface 2a, and the relative positional relationship changing between the display surface 2a and the user's finger.

The display surface 2a of the touch panel 2 includes a first region 2a1, in which first physical operators 3 described below are arranged, and a second region 2a2, in which first physical operators 3 are not arranged. The mechanism by which the touch panel 2 detects the electrostatic capacitance is the same in the first region 2a1 and the second region 2a2. However, the sensitivity with which the electrostatic capacitance is detected in the first region 2a1 is higher than the sensitivity with which the electrostatic capacitance is detected in the second region 2a2. The second region 2a2 mainly detects contact of the user's finger with the second region 2a2 through a change in the electrostatic capacitance.

In the first region 2a1, the electrostatic capacitance is detected as one of a plurality of levels. That is to say, in the first region 2a1, in addition to detecting whether or not the user's finger is in contact with the display surface 2a, the spacing between the display unit 117 and the user's finger is detected as one of a plurality of levels.

The physical operators 3 and 4 are operators that are physically operated by the user. The physical operators 3 and 4 include first physical operators 3 that are arranged on the display surface 2a, and second physical operators 4 that are arranged outside the display surface 2a.

As a result of being operated by the user, the first physical operators 3 change the electrostatic capacitance detected on the touch panel 2. The first physical operators 3 include push switches 10 that allow a push operation, and an encoder 20 (hereinafter, referred to as a first encoder 20) that allows a rotation operation.

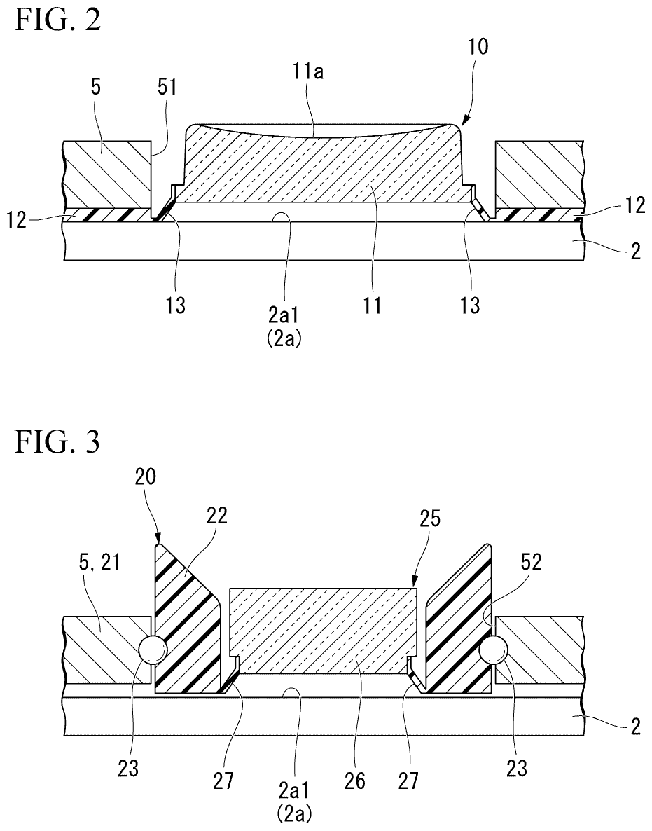

As shown in FIG. 2, the push switch 10 includes a key top 11, a support portion 12 that is placed on the display surface 2a, and a joint portion 13 that joins the key top 11 and the support portion 12. The joint portion 13 holds the key top 11 such that, in a state where the support portion 12 is placed on the display surface 2a, the key top 11 is arranged with a spacing from the display surface 2a. Furthermore, the joint portion 13 is elastically deformed when the key top 11 is pushed by the user's finger and moves toward the display surface 2a. A push operation of the push switch 10 by the user is performed as a result the key top 11 being pushed toward the display surface 2a by the user's finger. As a result of the pushing of the key top 11 by the user being released, the key top 11 returns to the original position due to the elastic force of the joint portion 13.

When a push operation of the push switch 10 is performed by the user's finger, the user's finger is brought into contact with a top surface 11a of the key top 11, which faces the same side as the display surface 2a (the upper side in FIG. 2). The top surface 11a of the key top 11 is recessed in a concave shape. The top surface 11a of the key top 11 may, for example, be bulging in a convex shape, or formed flat.

The first region 2a1 of the touch panel 2 mentioned above detects contact of the user's finger with the top surface 11a of the push switch 10, and the pushing of the push switch 10 through a change in the electrostatic capacitance. For example, when the user's finger makes contact with the top surface 11a of the key top 11, the electrostatic capacitance detected in the first region 2a1 changes. Furthermore, when the user's finger pushes the key top 11 toward the display surface 2a from the state of being in contact with the top surface 11a of the key top 11, because the finger approaches the display surface 2a, there is a further change in the electrostatic capacitance detected in the first region 2a1. That is to say, the first region 2a1 of the touch panel 2 distinguishes between a state in which the user's finger has made contact with the key top 11, and a state in which the key top 11 has been pushed, and detect the state. The first region 2a1 of the touch panel 2 may distinguish between, for example, a position in which the key top 11 has been pushed halfway, and a position in which the key top 11 has been completely pushed and detect the state. That is to say, the first region 2a1 of the touch panel 2 may detect a change in the pushing amount of the key top 11 at a plurality of levels.

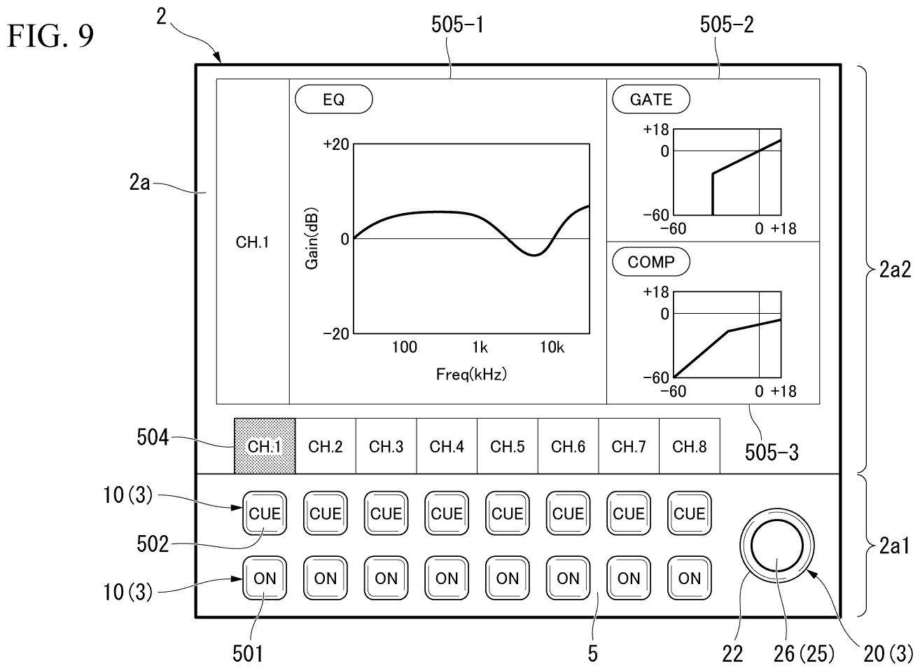

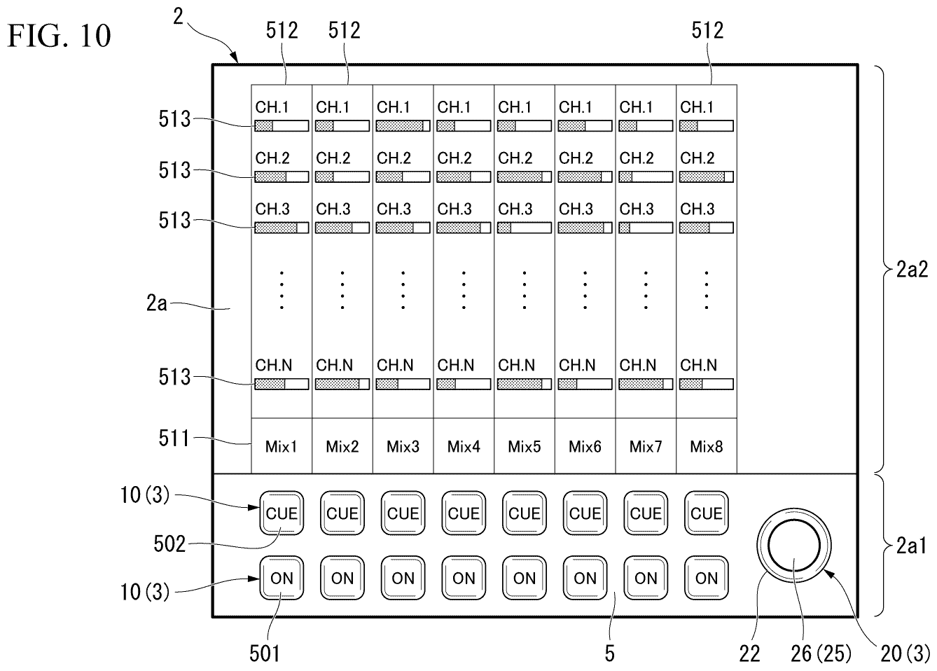

In the push switch 10 of the present embodiment, the key top 11 is configured as a light transmitting portion that transmits light. The key top 11 functioning as a light transmitting portion transmits light without scattering the light. Therefore, information such as characters, symbols, patterns, and images being displayed on the display surface 2a (for example, the icons 501 and 502 shown in FIGS. 9 and 10) are visible through the key top 11. In the present embodiment, the support portion 12 and the joint portion 13 of the push switch 10 are formed to be opaque so as to not transmit light. However, the support portion 12 and the joint portion 13 may, for example, transmit light while scattering the light, or may transmit light while not scattering the light in the same manner as the key top 11.

As shown in FIG. 3, a first encoder 20 includes a fixed portion 21 that is fixed on the display surface 2a of the touch panel 2, a rotation operation portion 22 that allows a rotation operation relative to the fixed portion 21 by the user's finger, and a bearing 23 provided between the fixed portion 21 and the rotation operation portion 22. As a result of the bearing 23 being interposed between the fixed portion 21 and the rotation operation portion 22, it is possible to smoothly rotate the rotation operation portion 22 relative to the fixed portion 21. The rotation operation portion 22 is arranged with a spacing with respect to the display surface 2a. The spacing between the rotation operation portion 22 and the display surface 2a is preferably small. However, the rotation operation portion 22 may, for example, be in contact with the display surface 2a.

In the first encoder 20 of the present embodiment, the rotation operation portion 22 is formed having a cylindrical shape. In addition, the first encoder 20 further includes a push operation portion 25 (inside portion) that is arranged on the inner side of the rotation operation portion 22. The push operation portion 25 is subjected to a push operation by the user's finger in the same manner as the push switch 10. That is to say, the push operation portion 25 includes a key top 26, and a joint portion 27 that joins the key top 26 and the rotation operation portion 22. The joint portion 27 holds the key top 26 such that the key top 26 is arranged with a spacing from the display surface 2a. Furthermore, the joint portion 27 is elastically deformed when the key top 26 is pushed by the user's finger, and moves toward the display surface 2a. A push operation of the push operation portion 25 by the user is performed as a result of the key top 26 being pushed toward the display surface 2a by the user's finger. As a result of the pushing of the key top 26 by the user being released, the key top 26 returns to the original position due to the elastic force of the joint portion 27.

The first region 2a1 of the touch panel 2, in which the first encoder 20 described above is arranged, detects a rotation operation of the first encoder 20 by the user through a change in the electrostatic capacitance. For example, when the user's finger rotates the rotation operation portion 22 while in contact with the rotation operation portion 22, the position of the user's finger that is in contact with the rotation operation portion 22 moves. Therefore, the electrostatic capacitance detected in the first region 2a1 changes.

Furthermore, the first region 2a1 also detects contact of the user's finger on the first encoder 20 through a change in the electrostatic capacitance. Specifically, the electrostatic capacitance detected in the first region 2a1 changes due to the user's finger making contact with the rotation operation portion 22 or the push operation portion 25 of the first encoder 20.

In addition, the first region 2a1 detects the pushing of the push operation portion 25 by the user's finger through a change in the electrostatic capacitance. Specifically, when the user's finger pushes the key top 26 toward the display surface 2a, because the finger approaches the display surface 2a, the electrostatic capacitance detected in the first region 2a1 changes.

In the first encoder 20, the three types of changes in the electrostatic capacitance take different forms to each other. Consequently, the first region 2a1 of the touch panel 2 distinguishes and detects a rotation operation of the rotation operation portion 22, contact of the user's finger with the first encoder 20, and a push operation of the push operation portion 25. The first region 2a1 of the touch panel 2 may detect a change in the pushing amount of the key top 26 of the push operation portion 25 at a plurality of levels.

In the first encoder 20 of the present embodiment, the key top 26 of the push operation portion 25 is configured as a light transmitting portion that transmits light. The key top 26 functioning as a light transmitting portion transmits light without scattering the light. Therefore, in addition to the colors and light displayed on the display surface 2a, information such as characters, symbols, patterns, and images being displayed on the display surface 2a (for example, the icons 501 and 502 shown in FIGS. 9 and 10) are visible through the key top 26. In the present embodiment, the rotation operation portion 22 and the fixed portion 21 of the first encoder 20 are formed to be opaque so as to not transmit light. However, the rotation operation portion 22 may, for example, transmit light while scattering the light, or may transmit light while not scattering the light in the same manner as the key top 26.

As shown in FIG. 1, the processing device 1 of the present embodiment includes a plurality (16 in FIG. 1) of the push switches 10 described above. The plurality of push switches 10 are joined together. Specifically, the plurality of key tops 11 are joined by the support portion 12 (see FIG. 2).

As shown in FIGS. 1 to 3, the processing device 1 of the present embodiment further includes a support body 5. The support body 5 is formed having a plate shape that is arranged so as to overlap the first region 2a1 of the display surface 2a.

The support body 5 integrally supports the plurality of first physical operators 3 (the plurality of push switches 10 and the first encoder 20). Specifically, of the support portion 12 that joins the key tops 11 of the plurality of push switches 10, the support body 5 is fixed to a surface that faces the opposite side to the display surface 2a. Moreover, the support body 5 is integrally formed with the fixed portion 21 of the first encoder 20.

In the support body 5, a plurality of first through-holes 51 and a second through-hole 52 that penetrate through in a plate thickness direction thereof are formed. In each of the first through-holes 51, a key top 11 of a push switch 10 is inserted. In the second through-hole 52, the rotation operation portion 22 and the push operation portion 25 of the first encoder 20 are inserted.

The support body 5 is formed to be opaque so as to not transmit light. As a result, the various information displayed in the first region 2a1 of the display surface 2a can only be viewed through the first and second through-holes 51 and 52 of the support body 5, and the key tops 11 of the push switches 10 and the key top 26 of the push operation portion 25 inserted therein.

The support body 5 described above is fixed to the touch panel 2 in a state where it is arranged overlapping the first region 2a1 of the display surface 2a. The support body 5 can be freely attached to, and detached from, the touch panel 2. As a result, the first physical operators 3 can be freely attached to, and detached from, the display surface 2a of the touch panel 2.

As shown in FIG. 1, the second physical operators 4 of the present embodiment include encoders 41 (hereinafter, referred to as second encoders 41) that allow a rotation operation, and faders 42 that allow a linear movement operation.

In the processing device 1, the lower section of the processing device 1 in FIG. 1 is located closer to the user, and the upper section of the processing device 1 is located away from the user. That is to say, the up-down direction in FIG. 1 corresponds to the up-down direction as seen by the user. Furthermore, the left-right direction in FIG. 1 corresponds to the left-right direction as seen by the user. Hereinafter, the arrangement of the first and second physical operators 3 and 4 will be described using the up-down direction and the left- right direction in FIG. 1.

The plurality of push switches 10 and the single first encoder 20 are arranged on the first region 2a1 of the touch panel 2, which is positioned adjacent to, and on the lower side of, the second region 2a2 of the touch panel 2. A plurality of push switches 10 (eight in FIG. 1) are arranged side-by-side in the left-right direction along the lower end of the second region 2a2 of the touch panel 2. The number of push switches 10 arranged side-by-side in the left-right direction corresponds to the number of predetermined channels (for example, the number of input channels 1120 and output channels 1140 described below). Furthermore, two sets of eight push switches 10 arranged side-by-side in the left-right direction are arranged side-by-side in the up-down direction. The single first encoder 20 is arranged on the right side of the eight push switches 10.

The plurality of second encoders 41 and the plurality of faders 42 are arranged on the lower side of the first region 2a1 of the touch panel 2, and more specifically, are arranged on the lower side of the plurality of push switches 10 described above. The plurality of second encoders 41 and the plurality of faders 42 (eight in FIG. 1) are, in the same manner as the push switches 10, each arranged side-by-side in the left-right direction with a spacing in the left-right direction. The number of second encoders 41 and faders 42 arranged side-by-side in the left-right direction corresponds to the number of predetermined channels. Each fader 42 is positioned on the lower side of a second encoder 41, and is arranged such that a linear movement operation can be performed in the up-down direction.

Two push switches 10, one second encoder 41, and one fader 42 that are arranged side-by-side in this order from top to bottom constitute a single channel strip. Further, in the processing device 1, eight channel strips are arranged side-by-side in the left-right direction. Among the first physical operators 3, the push switches 10 function as individually corresponding operators that correspond to each channel. On the other hand, of the first physical operators 3, the first encoder 20 functions as a collectively corresponding operator that corresponds to a plurality of channels.

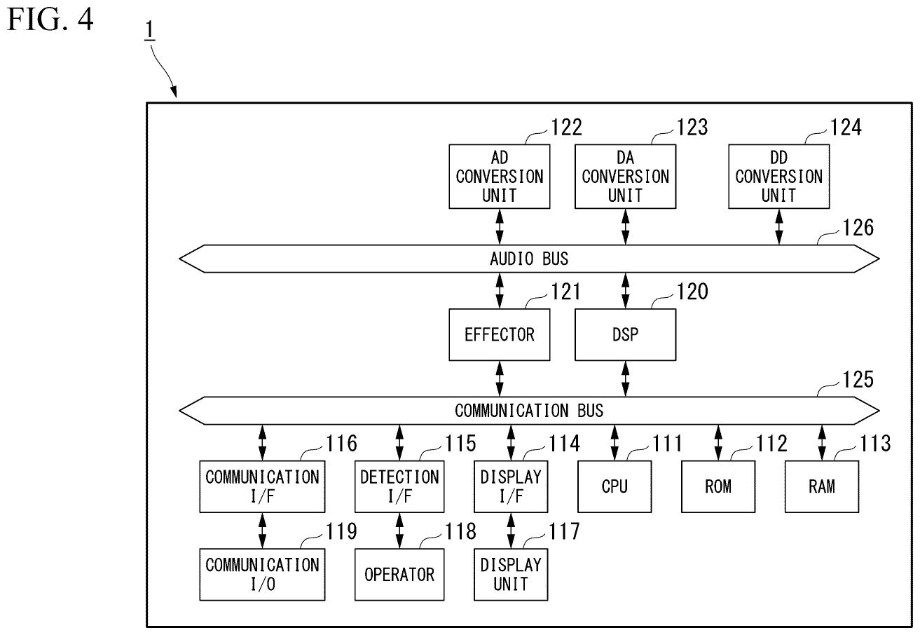

As shown in FIG. 4, the processing device 1 is a digital mixer including a CPU 111, a ROM 112, a RAM 113, a display interface (“I/F”) 114, a detection I/F 115, a communication I/F 116, a DSP (digital signal processor) 120, and an effector 121, and these are connected by a communication bus 125. Furthermore, a display unit 117 is connected to the display I/F 114. An operator 118 is connected to the detection I/F 115. A communication input/output (I/O) unit 119 is connected to the communication I/F 116. The processing device 1 further includes an AD conversion unit 122, a DA conversion unit 123, and a DD conversion unit 124, which are connected to the DSP 120 and the effector 121 via an audio bus 126.

The CPU 111 controls the overall operation of the processing device 1. The CPU 111 executes a predetermined program stored in the ROM 112 to perform processing such as the displaying of the display unit 117 via each I/F 114 to 116, detecting an operation of the operator 118, controlling communication via the communication I/O 119, and controlling signal processing in the DSP 120.

The ROM 112 is a rewritable non-volatile storage device that stores a control program or the like, which is executed by the CPU 111. The ROM 112 may be a flash memory or the like.

The RAM 113 is a storage device for storing parameter values to be reflected in the signal processing in the DSP 120, and for use as a work memory of the CPU 111.

The display I/F 114 is an interface for connecting the display unit 117 to the communication bus 125, and controlling the display contents in accordance with instructions from the CPU 111. The display unit 117 displays a screen showing the current state of the processing device 1, a screen for referencing, changing, and saving parameters used in the signal processing, and the like. The display unit 117 corresponds to a function that displays various types of information on the display surface 2a of the touch panel 2 described above.

The detection I/F 115 is an interface for connecting the operator 118 to the communication bus 125, and detecting the operation contents in accordance with instructions from the CPU 111. The operator 118 is an operator 118 that allows the user to directly operate the processing device 1 to edit parameters and the like. The operator 118 corresponds to the first physical operators 3 (the push switches 10 and the first encoder 20), the second physical operators 4 (the second encoders 41 and the faders 42), and a function of the touch panel 2 that detects a change in the electrostatic capacitance.

The communication I/F 116 is an interface for connecting the communication I/O 119 to the communication bus 125, and controlling data transmission and reception through the communication I/O 119 in accordance with instructions from the CPU 111. The communication I/O 119 is capable of communicating with external devices via a network or by peer-to-peer communication.

The DSP 120 is a signal processing device that includes a signal processing circuit, and performs signal processing with respect to an input audio signal in accordance with parameter values that are set so as to be reflected in the signal processing. The effector 121 has the function of applying various effects such as reverb and chorus effects to an input audio signal, and then outputting the signal.

The AD conversion unit 122 has the function of converting an analog audio signal input from each of a plurality of input terminals into digital waveform data, and then supplying the digital waveform data to an audio bus 126. The DA converter 123 has the function of converting each of the digital waveform data of a plurality of channels acquired from the audio bus 126 into an analog audio signal, and then outputting the analog audio signal from the output terminal associated with the waveform data. The DD conversion unit 124 has the function of performing format conversion required for inputting and outputting digital waveform data between the audio bus 126 and the terminals.

The audio bus 126 is capable of performing time-division transmission of digital waveform data over a plurality of channels, with each channel functioning as a signal transmission path that transmits a signal from the output of one of the processors (including the effector 121) or conversion units connected to the audio bus 126, to the input of another processor or conversion unit.

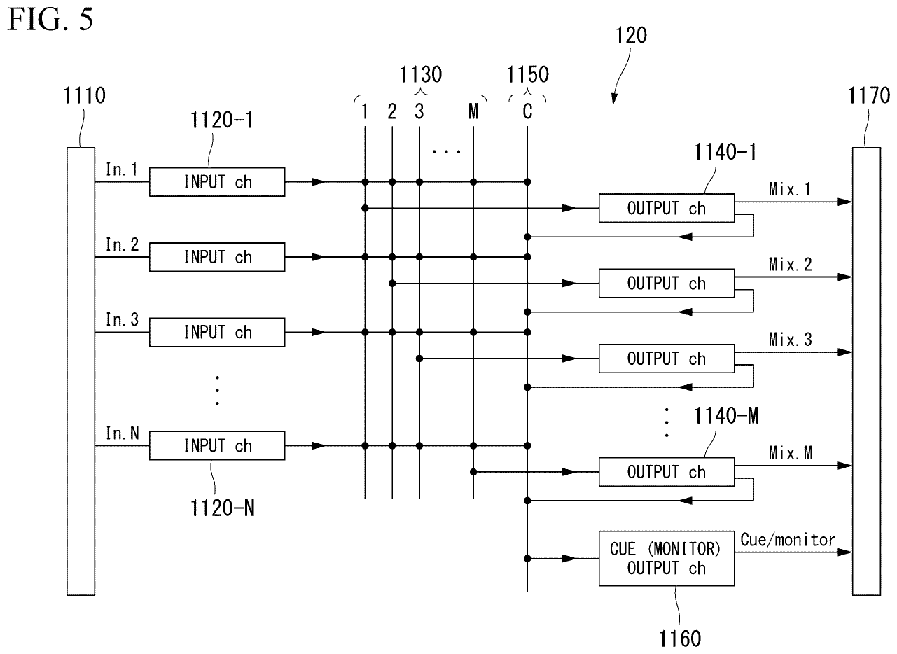

Next, the configuration of the signal processing executed in the DSP 120 shown in FIG. 4 will be described in more detail with reference to FIGS. 5 to 8.

As shown in FIG. 5, the signal processing in the DSP 120 includes an input patch 1110, input channels 1120, a mixing bus 1130, output channels 1140, a cue bus 1150, a cue output channel 1160, and an output patch 1170.

In the DSP 120, the input patch 1110 enables any one of the input ports prepared so as to correspond to an input terminal of the AD conversion unit 122 or the DD conversion unit 124 to be patched (wired) to each of N input channels 1120, namely a first (1120-1) to an Nth (1120-N) input channel 1120.

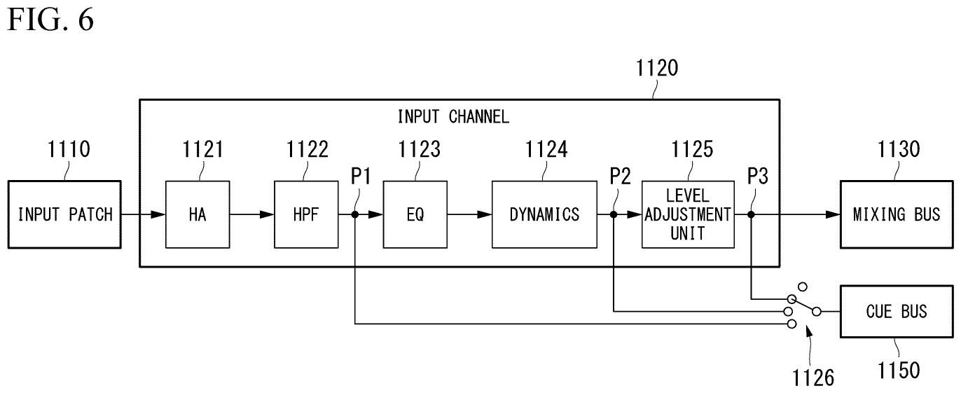

As shown in FIG. 6, each input channel 1120 has signal processing units that perform signal processing with respect to an audio signal input from an input port that has been patched by the input patch 1110. The input channel 1120 shown in FIG. 6 has, as signal processing units, a head amplifier (HA) 1121, a high pass filter (HPF) 1122, an equalizer (EQ) 1123, a dynamics 1124, and a level adjustment unit 1125, which are connected in this order from the input patch 1110 side. The input channel 1120 may also include other signal processing units such as an attenuator, a noise gate (GATE), a compressor (COMP), a delay (DELAY), a fader (LEVEL), or a pan (PAN).

In each input channel 1120, after the signal processing has been performed by the signal processing units, the processed signal is transmitted to an arbitrary bus of the M-line mixing bus 1130, which includes a first to Mth line. The output level and on/off of each channel of the input channels 1120 to each bus of the mixing bus 1130 can be set individually.

Furthermore, the input channel 1120 is capable of transmitting an audio signal that has been extracted from any one of extraction positions P1 to P3 provided in a plurality of locations (three locations in FIG. 6) to the cue bus 1150 as a preview listening signal. A cue switching switch 1126 switches between the extraction positions P1 to P3. The cue switching switch 1126 is controlled by the CPU 111 to select which of the contacts connected to the extraction positions P1 to P3 is to be connected.

In addition, only the input channel 1120 that the user has selected as a preview listening target transmits a signal to the cue bus 1150. When the input channel 1120 has not been selected, the cue switching switch 1126 selects a contact that is not connected to any of the extraction positions P1 to P3.

As shown in FIG. 5, in the mixing bus 1130 of each line, the signals input from each input channel 1120 are mixed, and the signals obtained after mixing are each output from the output channels 1140, namely a first (1140-1) to Mth (1140-M) output channel 1140 corresponding to each line.

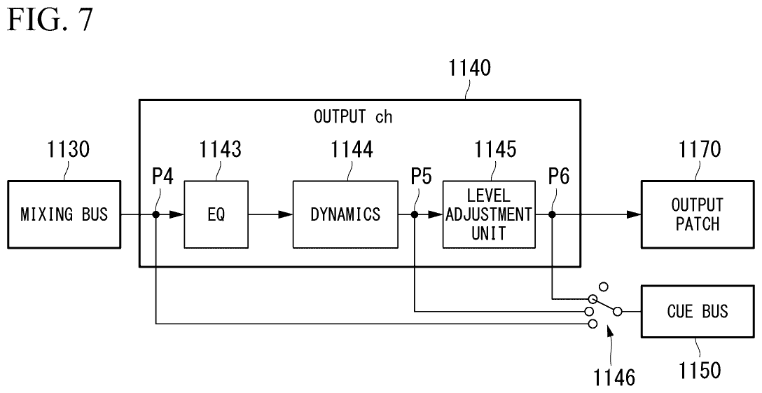

As shown in FIG. 7, each output channel 1140 has signal processing units that perform signal processing with respect to the audio signal that has been input from the corresponding mixing bus 1130. The output channel 1140 shown in FIG. 7 has, as signal processing units, an equalizer 1143, a dynamics 1144, and a level adjustment unit 1145, which are connected in this order from the mixing bus 1130 side. The output channel 1140 may include other signal processing units such as a compressor (COMP), a fader (LEVEL), a balance (BAL), a delay (DELAY), or an attenuator.

Moreover, as shown in FIG. 7, the output channel 1140 is capable of transmitting an audio signal that has been extracted from any one of extraction positions P4 to P6 provided in a plurality of locations (three locations in FIG. 7) to the cue bus 1150 as a preview listening signal. The cue switching switch 1146 is a switch that switches between the extraction positions P4 to P6 and that corresponds to the cue switching switch 1126. In addition, a signal is transmitted to the cue bus 1150 from only the output channel 1140 that the user has selected as the preview listening target. When the output channel 1140 has not been selected, the cue switching switch 1146 selects a contact that is not connected to any of the extraction positions P4 to P6.

As a function of the processing device 1, it is possible to simultaneously select an input channel 1120 and an output channel 1140 as preview listening targets. However, it is generally assumed that only one of the input channel 1120 and output channels 1140 will be selected as the preview listening target.

As shown in FIG. 5, the cue bus 1150 mixes the signals that have been input from each input channel 1120 and each output channel 1140, and outputs the mixed signal to the cue output channel 1160.

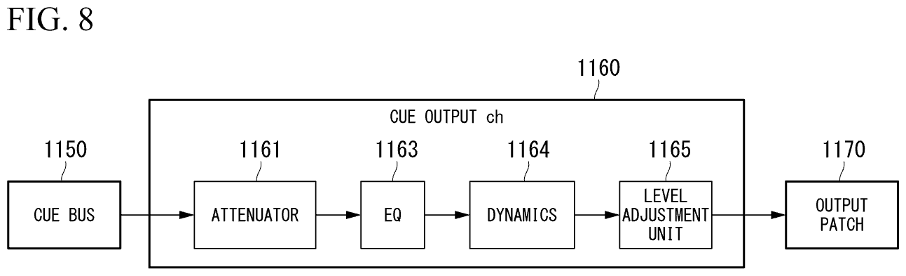

As shown in FIG. 8, in the cue output channel 1160, signal processing is performed with respect to the audio signal that has been input from the cue bus 1150 by each of the signal processing units, namely an attenuator 1161, an equalizer 1163, a dynamics 1164, and a level adjustment unit 1165.

The output patch 1170 patches each of the output channels 1140 and the cue output channel 1160 to output ports prepared so as to correspond to an output terminal provided in the DA conversion unit 123 or the DD conversion unit 124, supplies the signal that has been processed by each of the output channels 1140 and the cue output channel 1160 to the output port of the patch destination, and outputs the signal from the output port. The patch destination of the cue output channel 1160 is a fixed output port for monitor output.

The signal processing by each unit provided in the DSP 120 (such as the input channels 1120, the output channels 1140, and the cue output channel 1160) can be controlled by setting the values of predetermined parameters stored in a memory. Furthermore, the function of each unit provided in the DSP 120 may be realized by software, or realized by hardware.

The processing device 1 of the present embodiment includes a control unit that changes and adjusts the processing parameters in response to a change in the electrostatic capacitance of the touch panel 2 based on an operation of the first physical operators 3. Furthermore, in the processing device 1 of the present embodiment, the control unit changes and adjusts some of the processing parameters based on an operation of the second physical operators 4.

The “processing parameters” include parameters corresponding to each type of signal processing unit (such as equalizers, noise gates, and compressors) in the input channels 1120, the output channels 1140, and the cue output channel 1160 of the DSP 120 described above. In addition, the “processing parameters” may include the output levels of the signals that are output from each channel 1120, 1140, and 1160 to the subsequent bus 1130 and 1150 or output patch 1170, parameters that switch on/off the signal outputs, and parameters that switch the various display information that is displayed on the display surface 2a.

The control unit changes and adjusts, for each channel, the processing parameters corresponding to the audio signal that has been input to the channel. The control unit may be a program that is executed by the CPU 111 (see FIG. 4) mentioned above.

The operations of the first physical operators 3 that change the electrostatic capacitance include, as described above, contact and pushing of the push switches 10 by the user's finger, a rotation operation of the rotation operation portion 22 and contact and pushing of the push operation portion 25 of the first encoder 20 by the user's finger. Furthermore, the operations of the first physical operators 3 that change the electrostatic capacitance include an operation of the user's finger sliding so as to sequentially make contact with the plurality of first physical operators 3. For example, in the processing device 1 shown in FIG. 1, the user's finger slides so as to sequentially make contact with the plurality of push switches 10 arranged side-by-side in the left-right direction.

The control unit determines, for example, whether or not a sliding operation has been performed as follows. For example, from a state where the user's finger is in contact with the push switch 10 on the far left among the plurality of push switches 10 arranged side-by-side in the left-right direction, and the push switch 10 that the finger is in contact with sequentially changes in the right direction within a predetermined time such that the finger finally makes contact with the push switch 10 on the far right, the control unit determines that a sliding operation from the left to right has been performed. Similarly, the control unit determines whether or not a sliding operation has been performed from the right to left. The determination of a sliding operation by the control unit may be performed in a state where the push switches 10 have been pushed.

In the present embodiment, the control unit changes the processing parameters in response to the sliding operation. The change in the processing parameters due to the sliding operation may be, for example, switching of the display of the display surface 2a, a change in the input and output volume, a change in the channel displayed on the display surface 2a, switching of a function layer, or switching of the application of an effect. Here, an example of a function layer includes a channel layer. A channel layer refers to a group that at least one or more channels among all of the channels are divided into in a default setting, or a group that has been arbitrarily divided by the user. By switching the channel layer, the channels whose processing parameters are changed and adjusted by the first physical operators 3 and the second physical operators 4 can be changed.

The change in the processing parameters by the control unit in response to a sliding operation may be different for a sliding operation from left to right and a sliding operation from right to left. For example, the control unit may switch to a function layer with a large number (for example, a channel number) in response to a sliding operation from left to right, and switch to a function layer with a small number (for example, a channel number) in response to a sliding operation from right to left.

In the processing device 1 of the present embodiment, the display surface 2a of the touch panel 2 displays various icons (for example, the icons 501 and 502 shown in FIGS. 9 and 10) related to the processing parameters described above. The icons displayed on the display surface 2a may be characters, symbols, patterns, colors, images (still images), videos (moving images), and the like. The icons are displayed, for example, in a region overlapping the first physical operators 3, such that the icons are visible through the key tops 11 and 26 (light transmitting portions) of the first physical operators 3. The display surface 2a displays icons related to the processing parameters for each channel. That is to say, a plurality of icons may be displayed on the display surface 2a.

Moreover, on the display surface 2a of the touch panel 2, information related to a channel selected from among the plurality of channels is displayed in response to an input to the touch panel 2 accompanying a change in the electrostatic capacitance.

Further, the processing device 1 of the present embodiment includes a function selection unit. The function selection unit selects or changes the type of processing parameter and the icon corresponding to the processing parameter in response to an input to the touch panel 2 accompanying a change in the electrostatic capacitance. The input to the touch panel 2 accompanying a change in the electrostatic capacitance may be performed via operation of the first physical operators 3, or a direct input to the touch panel 2 (for example, an input due to the user's finger making contact with or approaching the display surface 2a). The selection of an icon by the function selection unit may involve changing the text, symbol, pattern, color, image (still image), or video (moving image), and may also include changing the display mode of the icon, such as the brightness.

Furthermore, in response to the first region 2a1 of the touch panel 2 detecting a change in the electrostatic capacitance at a plurality of levels, the function selection unit of the present embodiment selects or changes an icon in accordance with a change in the electrostatic capacitance of each level. For example, in response to a change in the electrostatic capacitance detected in the first region 2a1 due to the user's finger making contact with the key top 11 of a push switch 10, the function selection unit changes the icon that is visible through the key top 11 (for example, changes the icon to the characters “SEL”). Furthermore, in response to a further change in the electrostatic capacitance detected in the first region 2a1 caused by the user's finger pushing the key top 11 toward the display surface 2a from a state where the user's finger is in contact with the key top 11, the function selection unit further changes the icon that is visible through the key top 11 (for example, changes the icon to the characters “ON”).

The function selection unit may be a program that is executed by the CPU 111 (see FIG. 4) mentioned above.

The first physical operators 3 receive user operations corresponding to the type of processing parameter that has been selected in the function selection unit described above.

Next, the operation of the processing device 1 of the present embodiment configured as described above will be described with reference to FIG. 9 and FIG. 10.

FIG. 9 is a diagram showing a first display example of the display surface 2a of the processing device 1 of the present embodiment. In the first display example of FIG. 9, a plurality of channel names 504 and signal processing unit information 505 of the selected channel name 504 are displayed in the second region 2a2 of the display surface 2a.

The plurality of channel names 504 are arranged side-by-side in the left-right direction at the lower end of the second region 2a2, and correspond to each of the plurality of channel strips arranged side-by-side in the left-right direction. The number of channel names 504 displayed in the second region 2a2 is eight, which corresponds to the number of channel strips.

The channel names 504 displayed in FIG. 9 are the first (CH. 1) to the eighth (CH. 8) channels among the plurality of input channels 1120 mentioned above (see FIG. 5). However, the user may switch to displaying different channel names 504 by performing a predetermined operation with respect to the processing device 1. For example, when the number of input channels 1120 of the processing device 1 is 16, then as a result of the user performing a predetermined operation with respect to the processing device 1, the channel names 504 of the plurality of input channels 1120 displayed in the second region 2a2 can be switched between the first to eighth input channels 1120 (CH. 1 to 8) and the ninth to sixteenth input channels 1120 (CH. 9 to 16). The switching of the display of the channel names 504 may be performed, for example, as a result of the user sliding the user's finger so as to sequentially make contact with the plurality of push switches 10 arranged side-by-side in the left-right direction.

The plurality of channel names 504 displayed on the lower end of the second region 2a2 may also be, for example, the names of the output channels 1140 and the cue output channel 1160.

The signal processing unit information 505 is displayed on the upper side of the channel names 504 in the second region 2a2. The signal processing unit information 505 represents signal processing unit information 505 of a single input channel 1120 (CH. 1 in FIG. 9) that has been selected from among the plurality of input channels 1120 displayed in the channel names 504. In the channel names 504, the selected input channel 1120 (CH. 1) is displayed in a different mode (in FIG. 9, a different color) to the other input channels 1120 (CH. 2 to 8). The selection of the input channels 1120 may be performed as a result of the user's finger making contact with a predetermined input channel 1120 (for example, CH. 1) among the plurality of input channels 1120 displayed in the second region 2a2.

In FIG. 9, as the signal processing unit information 505, three pieces of information are displayed, namely an equalizer (EQ) 505-1, a noise gate (GATE) 505-2, and a compressor (COMP) 505-3 of the selected input channel 1120 (CH. 1).

The equalizer 505-1 is an equalizer that adjusts the frequency characteristics of the input audio signal. The equalizer 505-1 is configured to be capable of changing and adjusting the frequency characteristics of four frequency bands, for example, “HI”, “MID HI”, “LOW MID”, and “LOW”.

The noise gate 505-2 is a noise gate that blocks noise, and when the level of the input audio signal becomes less than or equal to a reference value, it rapidly decreases the gain of the input audio signal to block the noise. The noise gate 505-2 is capable of changing and adjusting the reference value.

The compressor 505-3 narrows the dynamic range of the input audio signal, which prevents the input audio signal from becoming saturated. The compressor 505-3 is capable of changing and adjusting the dynamic range.

The signal processing unit information 505 of the input channel 1120 displayed in the second region 2a2 is not limited to the above, and it may be, for example, a head amplifier, a high-pass filter, a dynamics, a level adjustment unit, and the like.

The parameters mentioned above (the equalizer 505-1, the noise gate 505-2, the compressor 505-3, and the like) may be changed and adjusted, for example, as a result of the user making contact with and directly operating the graph of each parameter displayed in the second region 2a2, or by the user operating the second encoder 41 and fader 42 (see FIG. 1) of the corresponding channel strip. Furthermore, the parameters may be changed or adjusted by, for example, the user operating the first encoder 20.

When the first encoder 20 is used, the parameters may be changed and adjusted by the user performing a rotation operation with respect to the rotation operation portion 22. When the first encoder 20 is used, for example, the parameters may be roughly changed or adjusted as a result of the user performing a rotation operation with respect to the rotation operation portion 22 in a state where the user's finger is not pushing, or is not in contact with, the push operation portion 25. Furthermore, the parameters may be finely changed or adjusted as a result of the user performing a rotation operation with respect to the rotation operation portion 22 in a state where the user's finger is pushing, or is contact with, the push operation portion 25. In a state where the user's finger is pushing, or is in contact with, the push operation portion 25, for example, an icon that indicates that the parameter is being finely changed or adjusted may be visible through the key top 26 of the push operation portion 25.

In the first display example of FIG. 9, the icons 501 and 502 individually corresponding to the plurality of push switches 10 are displayed in the first region 2a1 of the display surface 2a, in which the push switches 10 and the first encoder 20 are arranged. Of the two push switches 10 that are arranged side-by-side in the up-down direction, the icon 501 corresponding to the push switch 10 on the lower side contains the characters “ON”, which is visible through the key top 11 of the push switch 10 on the lower side. Furthermore, the icon 502 corresponding to the push switch 10 on the upper side contains the characters “CUE”, which is visible through the key top 11 of the push switch 10 on the upper side.

As a result of the push switch 10 on the lower side corresponding to the icon 501 containing “ON” being pushed, transmission of a signal from a predetermined input channel 1120 (for example, CH. 1) displayed in the channel name 504 to the mixing bus 1130 (see FIG. 5) is switched on/off. The predetermined push switch 10 on the lower side and the predetermined input channel 1120 that corresponds to this are arranged side-by-side in the up-down direction. In the present embodiment, the push switch 10 on the lower side is switched on when pushed while in the off state. After that, when the pushing of the push switch 10 on the lower side is released, the on state is maintained. In addition, the push switch 10 on the lower side is switched off when pushed again while in the on state. After that, when the pushing of the push switch 10 on the lower side is released, the off state is maintained.

The push switch 10 on the upper side corresponding to the icon 502 containing “CUE” is assigned to the cue switching switch 1126 (see FIG. 6) of the predetermined input channel 1120 (for example, CH. 1) displayed in the channel name 504. The predetermined push switch 10 on the upper side and the predetermined input channel 1120 that corresponds to this are arranged side-by-side in the up-down direction. As a result of pushing the push switch 10 on the upper side, the transmission of the signal to the cue bus 1150 (see FIG. 5) is switched on/off. In the present embodiment, the push switch 10 on the upper side is switched on when pushed while in the off state. After that, when the pushing of the push switch 10 on the upper side is released, the on state is maintained. In addition, the push switch 10 on the upper side is switched off when pushed again while in the on state. After that, when the pushing of the push switch 10 on the upper side is released, the off state is maintained.

The extraction positions P1 to P3 of the signal of the input channel 1120 (see FIG. 6) may be determined, for example, by an option setting displayed in the second region 2a2 of the display surface 2a. Furthermore, the extraction positions P1 to P3 of the signal of the input channel 1120 may be determined, for example, by using the fact that the change in the pushing amount of the push switch 10 is detected at a plurality of levels. Specifically, the extraction position P1 of the signal may be determined when the user's finger is only in contact with the push switch 10 and is not pushing the push switch 10, and the extraction position P2 may be determined when the user's finger has pushed the push switch 10 halfway. Moreover, the extraction position P3 may be determined when the user's finger has completely pushed the push switch 10.

FIG. 10 is a diagram showing a second display example of the display surface 2a of the processing device 1 of the present embodiment.

In the second display example of FIG. 10, a plurality of mixing bus names 511, and output level information 512 of the plurality of input channels 1120 corresponding to each mixing bus 1130 are displayed in the second region 2a2 of the display surface 2a.

The plurality of mixing bus names 511 are arranged side-by-side in the left-right direction at the lower end of the second region 2a2, and correspond to each of the plurality of channel strips arranged side-by-side in the left-right direction. The number of mixing bus names 511 displayed in the second region 2a2 is eight, which corresponds to the number of channel strips.

The mixing bus names 511 displayed in FIG. 10 are the first (Mix 1) to the eighth (Mix 8) buses among the plurality of mixing buses 1130 mentioned above (see FIG. 5). However, the user may switch to displaying different mixing bus names 511 by performing a predetermined operation with respect to the processing device 1. For example, when the number of mixing buses 1130 of the processing device 1 is 16, then as a result of the user performing a predetermined operation with respect to the processing device 1, the mixing bus names 511 displayed in the second region 2a2 can be switched between the first to eighth mixing buses 1130 (Mix 1 to 8) and the ninth to sixteenth mixing buses 1130 (Mix 9 to 16). The switching of the display of the mixing bus names 511 may be performed, for example, as a result of the user sliding the user's finger so as to sequentially make contact with the plurality of push switches 10 arranged side-by-side in the left-right direction.

The output level information 512 of the plurality of input channels 1120 corresponding to each mixing bus 1130 is arranged on the upper side of each mixing bus name 511. In the output level information 512, an output level 513 of each input channel 1120 is indicated by a gauge that extends in the left-right direction. The number of input channels 1120 corresponding to each mixing bus 1130 is the number (N channels) shown in FIG. 5.

Furthermore, the output levels 513 may be changed or adjusted by, for example, the user directly making contact with and operating the output levels 513 displayed in the second region 2a2. In addition, the output levels 513 may be changed or adjusted by, for example, the user operating the first encoder 20.

When the first encoder 20 is used, the output levels 513 may be changed and adjusted by the user performing a rotation operation with respect to the rotation operation portion 22. When the first encoder 20 is used, for example, the output level 513 may be roughly changed or adjusted as a result of the user performing a rotation operation with respect to the rotation operation portion 22 in a state where the user's finger is not pushing, or is not in contact with, the push operation portion 25. Furthermore, the output level 513 may be finely changed or adjusted as a result of the user performing a rotation operation with respect to the rotation operation portion 22 in a state where the user's finger is pushing, or is in contact with, the push operation portion 25. In a state where the user's finger is pushing, or is in contact with, the push operation portion 25, for example, an icon that indicates that the output level 513 is being finely changed or adjusted may be visible through the key top 26 of the push operation portion 25.

In the second display example of FIG. 10, in the same manner as the first display example of FIG. 9, the icons 501 and 502 individually corresponding to the plurality of push switches 10 are displayed in the first region 2a1. Furthermore, of the two push switches 10 that are arranged side-by-side in the up-down direction, the icon 501 including “ON” corresponds to the push switch 10 on the lower side, and the icon 502 including “CUE” corresponds to the push switch 10 on the upper side.

As a result of the push switch 10 on the lower side corresponding to the icon 501 containing “ON” being pushed, the transmission of a signal from a predetermined mixing bus 1130 (for example, Mix 1) displayed in the mixing bus name 511 to the output patch 1170 can be switched on/off. The predetermined push switch 10 on the lower side and the predetermined mixing bus 1130 that corresponds to this are arranged side-by-side in the up-down direction.

The push switch 10 on the upper side corresponding to the icon 502 containing “CUE” is assigned to the cue switching switch 1146 (see FIG. 7) of the output channel 1140 that is connected subsequently to the predetermined mixing bus 1130 (for example, Mix 1) displayed in the mixing bus name 511. The predetermined push switch 10 on the upper side and the predetermined mixing bus 1130 that corresponds to this are arranged side-by-side in the up-down direction. As a result of pushing the push switch 10 on the upper side, the transmission of the signal from the mixing bus 1130 to the cue bus 1150 (see FIG. 5) is switched on/off.

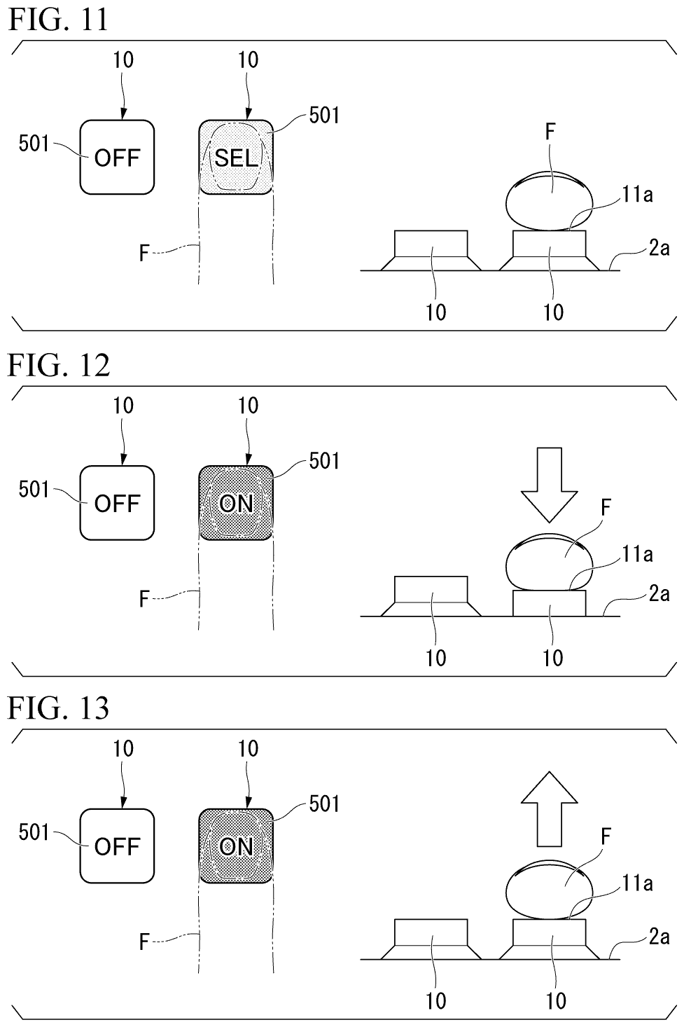

Next, an example of the relationship between the operation of the push switch 10 by a user's finger F and the change in display mode of the icon 501 corresponding to the push switch 10 will be described with reference to FIGS. 11 to 15.

For example, as shown in FIG. 11, when the user's finger F is in contact with the top surface 11a of the push switch 10, the display mode of the icon 501 is changed in accordance with the change in the electrostatic capacitance between the display surface 2a and the finger F. In the example shown in FIG. 11, the characters and color of the icon 501 change. Specifically, the icon 501 corresponding to the push switch 10 with which the user's finger F is not in contact and is in the off state is displayed in white with the characters “OFF”. The icon 501 corresponding to the push switch 10 in the off state with which the user's finger F is in contact is displayed in light gray with the characters “SEL”. As a result of such a change in the display mode of the icon 501, it is possible to cause the user to recognize that the finger F is in contact with the push switch 10 in the off state. The characters “SEL” mean that the finger F is in contact with the push switch 10 and has selected the push switch 10, and that the channel corresponding to the channel strip to which the push switch 10 belongs is selected. At this time, the parameters of the channel selected as a result of the finger F making contact with the push switch 10 (for example, the signal processing unit information 505 illustrated in FIG. 9) are displayed in the second region 2a2 of the display surface 2a.

As shown in FIG. 12, from the state in which the user's finger F is in contact with the top surface 11a of the push switch 10, when the push switch 10 is pushed toward the display surface 2a by the user's finger F, the push switch 10 is switched to the on state, and the display mode of the icon 501 is further changed in accordance with the change in the electrostatic capacitance between the display surface 2a and the finger F. Specifically, the characters of the icon 501 corresponding to the push switch 10 change from “SEL” to “ON”, and the color of the icon 501 also changes from light gray to dark gray. The icon 501 shown in dark gray with the characters “ON” indicates that the push switch 10 is in the on state. As a result of such a difference in the display mode of the icon 501, it is possible to cause the user to recognize that the push switch 10 has switched from the off state to the on state.

In the present embodiment, after the push switch 10 is pushed and switched to the on state, the on state of the push switch 10 is maintained even when the pushing of the push switch 10 is released. As a result, as shown in FIG. 13, even when the electrostatic capacitance between the display surface 2a and the finger F changes by releasing the pushing by the finger F of the push switch 10 in the on state, the display mode of the icon 501 does not change, the characters remain as “ON”, and the color remains dark gray. Further, even when the finger F separates from the push switch 10, the on state of the push switch 10 is maintained, the display mode of the icon 501 remains “ON”, and the color also remains dark gray.

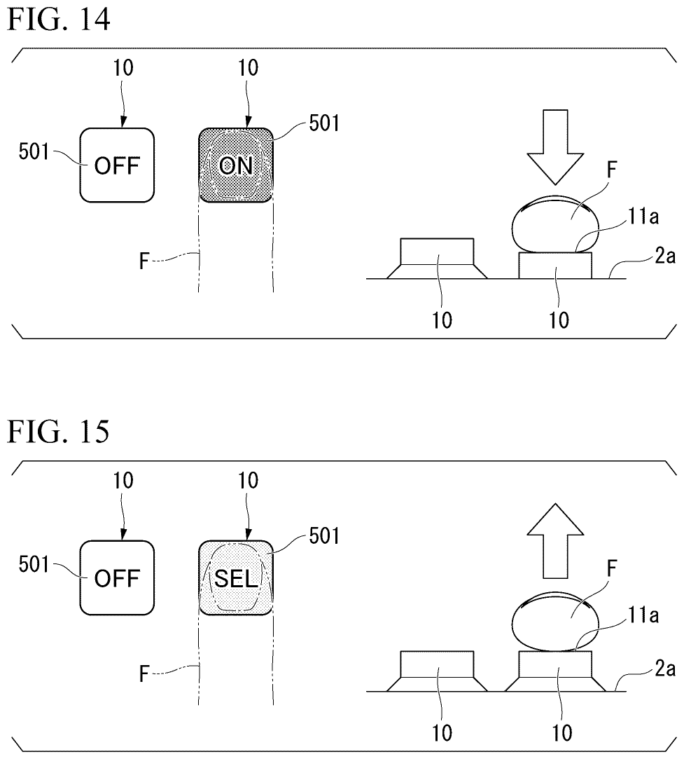

As shown in FIG. 14, in a state where the push switch 10 in the on state is pushed toward the display surface 2a by the user's finger F, the on state of the push switch 10 is maintained. As a result, even when the pushing motion of the push switch 10 by the user's finger F is accompanied by a change in the electrostatic capacitance, the display mode of the icon 501 does not change, the characters remain as “ON”, and the color remains dark gray.

Then, as shown in FIG. 15, when the pushing of the push switch 10 by the finger F is released, the push switch 10 is switched to the off state, and the display mode of the icon 501 is changed in accordance with the change in the electrostatic capacitance between the display surface 2a and the finger F. Specifically, the characters of the icon 501 corresponding to the push switch 10 change from “ON” to “SEL”, and the color of the icon 501 also changes from dark gray to light gray. In addition, as a result of releasing the finger F from the top surface 11a of the push switch 10, the characters of the icon 501 change from “SEL” to “OFF”, and the color of the icon 501 also changes from light gray to white. As a result of such a change in the display mode of the icon 501, it is possible to cause the user to recognize that the push switch 10 has switched from the on state to the off state.

In the example shown in FIGS. 11 to 15, white, light gray and dark gray are used as a combination of three colors of the icon 501 indicating the state of the push switch 10. However, for example, an arbitrary combination of colors such as blue, yellow, and red may be used.

The relationship between the operation of the push switch 10 by the user's finger F and the change in display mode of the icon 501 corresponding to the push switch 10 is not limited to the relationship described above.

For example, when the finger F separates from the push switch 10 in the off state whose icon 501 is displaying the characters “SEL” in response to contact by the user's finger, the characters of the icon 501 may be changed from “SEL” to “OFF”.

Furthermore, for example, when the finger F makes contact with the push switch 10 in the on state whose corresponding icon 501 is displaying the characters “ON”, the characters of the icon 501 may be changed from “ON” to “SEL”. Then, as a result of the finger F separating from the push switch 10, the icon 501 may be changed from “SEL” to “ON”.

As described above, according to the processing device 1 of the present embodiment, the touch panel 2 detects a change in the electrostatic capacitance accompanying an operation of the first physical operators 3. As a result, different changes in the electrostatic capacitance can be detected by the touch panel 2 in accordance with the type of operation of the first physical operators 3 performed by the user (for example, an operation that makes contact with the first physical operator 3, and an operation that moves the first physical operator 3). That is to say, a single first physical operator 3 can be provided with a plurality of functions. As a result, the number of first physical operator 3 provided in the processing device 1 can be reduced. Therefore, the size of the processing device 1 can be reduced. In addition, by reducing the number of first physical operators 3, the production cost of the processing device 1 can also be reduced.

Furthermore, the user is capable of recognizing where the finger is touching by touching the first physical operators 3 with the finger without looking at the processing device 1. For example, in a state where the finger is in contact with a first physical operator 3, it is possible to operate the first physical operator 3 with the right timing while looking at another location. Therefore, the usability (ease of use) of the processing device 1 can be ensured.

In addition, in the processing device 1 of the present embodiment, the key tops 11 and 26 of the push switches 10 and the first encoder 20 are light transmitting portions that allows light to pass therethrough. As a result, the user is capable of easily recognizing the functions of the push switches 10 and the first encoder 20 by visually confirming the icons displayed on the display surface 2a through the key tops 11 and 26 of the push switches 10 and the first encoder 20.

Also, in the processing device 1 of the present embodiment, the mechanism that detects a change in the electrostatic capacitance of the touch panel 2 is the same in the first region 2a1 and the second region 2a2. Therefore, compared to a case where the mechanism that detects a change in the electrostatic capacitance is different between the first and second regions 2a1 and 2a2, the structure of the touch panel 2 can be simplified.

Further, in the processing device 1 of the present embodiment, in the first region 2a1 in which the first physical operators 3 are arranged, the spacing between the display surface 2a and the user's finger operating the first physical operators 3 is larger than the spacing between the display surface 2a in the second region 2a2 in which the first physical operators 3 are not arranged and the user's finger. As a result, in the first region 2a1, the electrostatic capacitance generated between the display surface 2a and the user's finger becomes small compared to the second region 2a2. In contrast, by making the sensitivity with which a change in the electrostatic capacitance is detected in the first region 2a1 higher than in the second region 2a2, the touch panel 2 is capable of correctly detecting a change in the electrostatic capacitance based on an operation of the first physical operators 3 by the user's finger.

For example, when the first physical operators 3 are push switches 10 that allow a push operation, even when the change in the pushing amount of a push switch 10 by the user's finger is small, that is to say, even when the change in the distance between the touch panel 2 and the user's finger that is in contact with the top surface 11a of the push switch 10 is small, the touch panel 2 is capable of correctly detecting the change in the distance.

Moreover, in the processing device 1 of the present embodiment, the electrostatic capacitance is detected at a plurality of levels in the first region 2a1, in which the push switches 10 are arranged. As a result, the touch panel 2 is capable of detecting a change in the pushing amount of the push switches 10 by the user's finger at a plurality of levels. For example, the touch panel 2 is capable of detecting at three levels, namely a first level in which the user's finger is in contact with the push switch 10, a second level in which the push switch 10 has been pushed halfway, and a third level in which the push switch 10 has been completely pushed.

In addition, in the processing device 1 of the present embodiment, the plurality of first physical operators 3 are integrally supported by the support body 5. As a result, the relative positions of the plurality of first physical operators 3 are fixed, and the plurality of first physical operators 3 can be treated as a single operator module. Consequently, the plurality of first physical operators 3 can be simultaneously and easily arranged on the display surface 2a.

Furthermore, in the processing device 1 of the present embodiment, the plurality of push switches 10 are joined. As a result, the relative positions of the plurality of the push switches 10 are fixed, and the plurality of push switches 10 can be treated as a single module. Consequently, the plurality of push switches 10 can be simultaneously and easily arranged on the display surface 2a.

In addition, in the processing device 1 of the present embodiment, the plurality of first physical operators 3 can be freely attached to, and detached from, the display surface 2a. As a result, the first physical operators 3 can be arranged in positions on the display surface 2a that are easy for the user to use. The first region 2a1 of the display surface 2a, which has a high electrostatic capacitance sensitivity, may be appropriately set in accordance with the positions in which the first physical operators 3 are arranged.

Moreover, in the processing device 1 of the present embodiment, the control unit changes the processing parameters as a result of the user's finger sliding so as to sequentially make contact with the plurality of push switches 10. Using the plurality of push switches 10 arranged on the display surface 2a of the touch panel 2, it is possible to change the processing parameters with an intuitive operation of sequentially making contact with the plurality of push switches 10. Further, as a result of adding a new operation method (function) of sequentially making contact with the plurality of push switches 10, it is possible to further reduce the number of push switches 10 provided in the processing device 1, and to further reduce the size and production cost of the processing device 1.

Also, in the processing device 1 of the present embodiment, the touch panel 2 detects contact of the user's finger with the push switches 10 and pushing of the push switches 10 through a change in the electrostatic capacitance. As a result, a single push switch 10 can be provided with at least two functions (a contact function and a pushing function). In the present embodiment, it is possible to provide the plurality of push switches 10 with a new single function (sliding function) as mentioned above.

In addition, in the processing device 1 of the present embodiment, the top surface 11a of the key top 11 of the push switch 10, with which the user's finger makes contact, is recessed in a concave shape. As a result, compared to a case where the top surface 11a is not recessed, it is possible for the user's finger that is in contact with the top surface 11a to be brought closer to the display surface 2a of the touch panel 2. Consequently, even if the detection accuracy of a change in the electrostatic capacitance in the touch panel 2 is low, it is possible to detect that the user's finger is in contact with the push switch 10 with more certainty through a change in the electrostatic capacitance.

Also, in the processing device 1 of the present embodiment, the touch panel 2 detects both contact of the user's finger with the first encoder 20 and a rotation operation of the first encoder 20 through a change in the electrostatic capacitance. As a result, a single first encoder 20 can be provided with two functions (a contact function and a rotation function).

Furthermore, in the processing device 1 of the present embodiment, the first encoder 20 has a cylinder-shaped rotation operation portion 22, which is subjected to a rotation operation by the user's finger, and a push operation portion 25, which is subjected to a push operation by the user's finger. As a result, a single first encoder 20 can be provided with one additional function (pushing function). Furthermore, because a single first encoder 20 has a rotation function and a pushing function, various operations can be performed. For example, a new operation can be performed in which the rotation operation portion 22 is rotated while the push operation portion 25 is being pushed. In addition, it is also possible to perform an operation in which functions and processing are selected by rotating the rotation operation portion 22, and the functions and processing are determined by pushing the push operation portion 25.

In addition, in the processing device 1 of the present embodiment, the first encoder 20 includes a fixed portion 21 that is fixed to the touch panel 2, a rotation operation portion 22 that allows a rotation operation relative to the fixed portion 21, and a bearing 23 provided between the fixed portion 21 and the rotation operation portion 22. As a result, a rotation operation of the rotation operation portion 22 can be smoothly performed due to the bearing 23.

Moreover, in the processing device 1 of the present embodiment, the function selection unit changes an icon in accordance with a change in a processing parameter based on an operation of the first physical operators 3. For example, the color of an icon changes in accordance with a change in a parameter based on a contact operation and a push operation of the push switches 10. In this way, as a result of a change in the icons that are visible through the first physical operators 3 in response to an operation of the first physical operators 3, the user is capable of easily recognizing the state of the processing parameters by an operation of the first physical operators 3.

The present disclosure has been described in detail above. However, the present disclosure is not limited to the embodiments above, and various changes may be applied within a scope not departing from the spirit of the present disclosure.

In the present disclosure, the push switch 10 may include, for example, a switch body, and a conductive layer that is coated on the surface of the switch body. The switch body may be the key top 11 of the embodiment described above.

The conductive layer being coated on the surface of the switch body (key top 11) means that the region of the switch body with which the finger makes contact, and the region opposing the display surface 2a are electrically connected by the conductive layer. As a result, even if the detection accuracy of a change in the electrostatic capacitance in the touch panel 2 is low, and further, even if the spacing between the user's finger that is in contact with the switch body and the display surface 2a is large, the touch panel 2 is capable of correctly detecting a change in the electrostatic capacitance due to both the finger making contact with and pushing the push switch 10.

The configuration in which a conductive layer is coated is not limited to the push switch 10, and may also be applied, for example, to the push operation portion 25 of the first encoder 20.

In the present disclosure, the push switch 10 is not limited to being used as an “ON” switch (ON/OFF switch) and a “CUE” switch, and for example, it may be used as a “SEL” switch, or used as a user-defined key. The “SEL” switch may be a switch (select switch) that selects the channel whose processing parameters are changed and adjusted by a physical operator.

In the present disclosure, a push switch 10 used as an “ON” switch is not limited to functioning as a simple ON/OFF switch, and may, for example, function as a “SEL” (selection) switch in response to the finger making contact with the push switch 10, and function as an ON/OFF switch in response to pushing of the push switch 10.

In the present disclosure, the display mode (for example, the color) of an icon may be changed at a plurality of levels, for example, in accordance with a change in the pushing amount of the push switch 10.

In the present disclosure, the first encoder 20 may, for example, not include the push operation portion 25 and allow only a rotation operation. Even a first encoder 20 having such a configuration may include a light transmitting portion that transmits light.

In the present disclosure, the first encoder 20 may have a rotation operation range that is not limited, or a rotation operation range that is limited. Furthermore, the value of the processing parameter that is changed with a rotation operation of the first encoder 20 may have an upper limit value or a lower limit value, or may not have an upper limit value or a lower limit value.

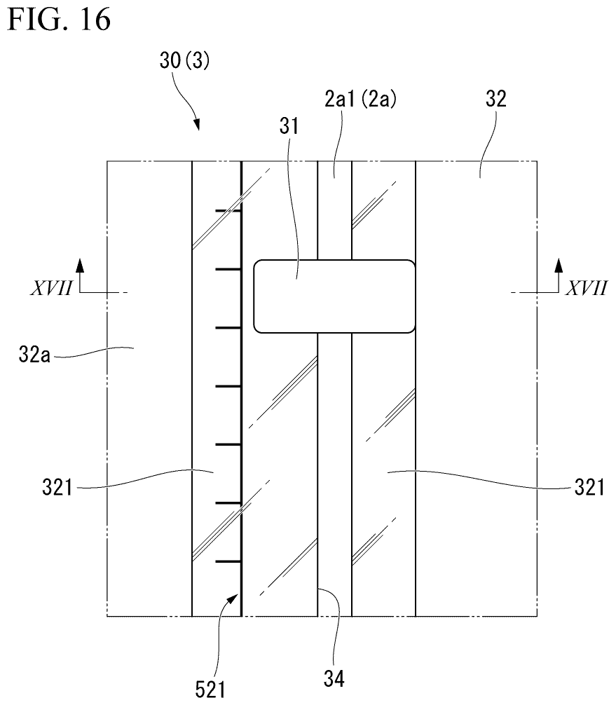

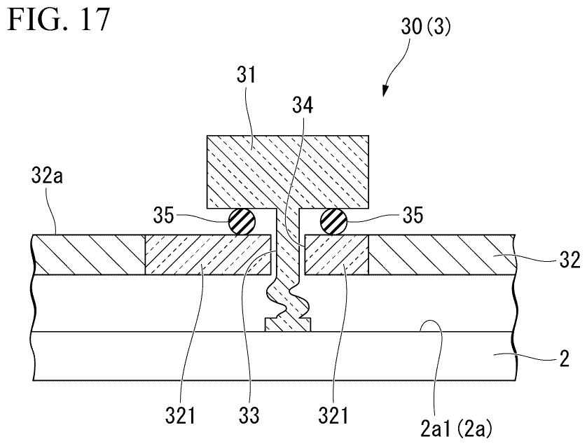

In the present disclosure, the first physical operators 3 arranged in the first region 2a1 of the display surface 2a may be, for example, as shown in FIGS. 16 and 17, a fader 30 that allows a linear movement operation along the display surface 2a. In this case, the touch panel 2 detects a linear movement operation of the fader 30 through a change in the electrostatic capacitance.

The fader 30 includes a knob portion 31 and a cover portion 32. The knob portion 31 is a part that is operated by the user's finger. The cover portion 32 is arranged on the display surface 2a. The cover portion 32 includes a guide groove 34. The guide groove 34 is formed having a groove shape that extends linearly, and guides the knob portion 31 in a linear direction (the up-down direction in FIG. 16). The cover portion 32 may be integrally formed, for example, with the support body 5 of the embodiment described above (see FIGS. 1 to 3).

Specifically, the knob portion 31 is arranged on an upper surface 32a of the cover portion 32. The knob portion 31 is integrally formed with an insertion portion 33 that is inserted through the guide groove 34 of the cover portion 32. The front end portion of the insertion portion 33 extending from the knob portion 31 may make contact with the display surface 2a as illustrated in FIG. 17, for example, but may not make contact. As a result of the insertion portion 33 being inserted through the guide groove 34, it is possible to guide the knob portion 31 along the longitudinal direction of the guide groove 34 (the up-down direction in FIG. 16).

An elastically deformable elastic body 35 is arranged between the knob portion 31 and the upper surface 32a of the cover portion 32. As a result, in the fader 30, it is possible to perform a push operation in which the knob portion 31 is pushed toward the display surface 2a. The touch panel 2 detects the pushing of the knob portion 31 by the user's finger through a change in the electrostatic capacitance.

In addition, in the fader 30 shown in FIGS. 16 and 17, a part 321 of the cover portion 32 that is adjacent to the guide groove 34 in the width direction (the left-right direction in FIGS. 16 and 17) is formed as a light transmitting portion that allows transmission of light. Further, of the cover portion 32, the region of the display surface 2a that overlaps with the guide groove 34 and the part 321 of the cover portion 32 formed as a light transmitting portion is displayed with an icon related to a processing parameter. The icon may be, for example, a gauge representing a gain value of a processing parameter (for example, output audio) that is output from the input channels 1120 or the output channels 1140. The gauge only needs to extend in the longitudinal direction of the guide groove 34. Also, the icon may be, for example, as shown in FIG. 16, a scale 521 of a processing parameter.

In addition, in the fader 30 shown in FIGS. 16 and 17, the knob portion 31 is formed as a light transmitting portion that allows transmission of light.

In the fader 30 illustrated in FIGS. 16 and 17, the gain value of the processing parameter (for example, output audio) that is changed based on an operation of the knob portion 31 can be displayed in a region of the display surface 2a corresponding to the guide groove 34 or the part 321 of the cover portion 32 that is adjacent to the guide groove 34. As a result, the dimensions of the fader 30 in the width direction of the guide groove 34 can be made smaller. That is to say, the fader 30 can be compactly configured.

Furthermore, in the fader 30 illustrated in FIGS. 16 and 17, as a result of the knob portion 31 being formed as a light transmitting portion, and by displaying an icon indicating the function of the fader 30 in a region of the display surface 2a corresponding to the position of the knob portion 31, the function that has been assigned to the fader 30 can be easily recognized. Moreover, even when the function that has been assigned to the fader 30 changes, information indicating the function of the fader 30 can be easily changed by simply changing the icon that is displayed on the display surface 2a.

In the fader 30 illustrated in FIGS. 16 and 17, the touch panel 2 detects the contact of the user's finger with the knob portion 31, pushing of the knob portion 31, and linear movement of the knob portion 31 through a change in the electrostatic capacitance. As a result, a single fader 30 can be provided with a plurality of functions. For example, by performing a linear movement of the knob portion 31 while making contact with the knob portion 31, the user is capable of adjusting the volume of audio being listened to through headphones or the like. In addition, the volume of the output audio can be adjusted by performing a linear movement while pushing the knob portion 31. Also, the volume can be roughly adjusted by a linear movement of the knob portion 31 while making contact with the knob portion 31, and the volume can be finely adjusted by a linear movement while pushing the knob portion 31.

In the present disclosure, the push switches 10 and the first encoder 20 illustrated in FIGS. 1 to 3, and the fader 30 illustrated in FIGS. 16 and 17 may be provided in the same processing device.

In the present disclosure, for example, the plurality of first physical operators 3 may be individually arranged on the display surface 2a of the touch panel 2. Furthermore, the plurality of first physical operators 3 may be individually freely attached to, and detached from, the display surface 2a of the touch panel 2.

The processing device of the present disclosure may be applied, for example, to a video processing device that executes signal processing with respect to an input video signal (a video-related signal), and then outputs the signal to the outside. In this case, the icons displayed on the display surface 2a and related to the processing parameters may, for example, be moving images. In this case, as a result of displaying the icons as sample moving images (thumbnail moving images) after processing in the video processing device, the user is capable of easily comparing the video with and without processing.

In addition, the processing device of the present disclosure may, for example, be applied to an electronic musical instrument that outputs sound.

For example, it is considered that, when the processing device of the present disclosure is applied to a synthesizer, which is a type of electronic musical instrument, various waveforms (sawtooth waves, square waves, and recorded sound signals) are input to the channels as signals, and an effector is used as a processing parameter to apply appropriate audio to the waveform, and a simple image imitating the effector may be displayed as an icon while transmitting through a physical operator. As a result, it is possible to turn on/off an effect of the waveform in response to a user operation with respect to the physical operator. Moreover, by setting the electrostatic capacitance to be detected at a plurality of levels or detected continuously, the degree in which the effect is applied can be adjusted in accordance with, for example, the pushing amount of a push switch (the position of the finger with respect to the display surface of the touch panel). Also, by applying special effects (for example, increasing the harmonics of the input waveform or applying extremely deep reverb) that are only expressed when a sliding operation is performed with respect to a plurality of physical operators, it is possible to obtain a visual performance effect through a performance.

Furthermore, it is considered that, when the processing device of the present disclosure is applied to a sampler, which is a type of electronic musical instrument, a sampled sound source is associated with each physical operator, and when a physical operator is operated, the sound source is input to a channel to produce sound (in this case, the channel corresponds to the output channel). In addition, as a processing parameter, a parameter is used which determines whether or not the sampled sound source is to be sent to a channel. In this case, if the physical operator accepts finger positions at a plurality of levels, the volume of the sound source may be determined, for example, by the pushing amount of a push switch (the position of the finger with respect to the display surface of the touch panel). Also, with respect to a sliding operation, a special effect may be defined in advance, in a similar manner to the example of the synthesizer.

According to the present disclosure, it is possible to achieve a reduction in the size and cost of an audio and video processing device and a processing device, while ensuring the usability of the audio and video processing device and processing device.

### <Appendix>

### (Item 1)

An audio and video processing device comprising:

a channel to which a signal related to at least one of audio and video is input;

a control unit that changes a processing parameter corresponding to the signal that has been input to the channel;

a touch panel that has a display surface that displays an icon corresponding to the channel and related to the processing parameter, and that detects a change in electrostatic capacitance accompanying a user operation;

a physical operator that is arranged on the display surface, and that changes the electrostatic capacitance detected by the touch panel in response to being operated by a user; and

a function selection unit that, in response to an input to the touch panel accompanying a change in the electrostatic capacitance via the operation of the physical operator, selects a type of processing parameter and the icon corresponding to the processing parameter,

wherein the control unit changes the processing parameter in accordance with the change in the electrostatic capacitance based on the operation of the physical operator, and

wherein the physical operator receives a user operation corresponding to the processing parameter selected by the function selection unit.

### (Item 2)

The audio and video processing device according to item 1,

wherein the channel comprises a plurality of channels, and

wherein the physical operator comprises a collectively corresponding operator that corresponds to the plurality of channels.

### (Item 3)

The audio and video processing device according to item 2,

wherein the display surface has a first region in which the physical operator is arranged, and a second region in which the physical operator is not arranged, and

the second region displays information related to the channel that has been selected in response to an input to the touch panel.

### (Item 4)

A processing device comprising:

a touch panel that has a display surface that displays an icon related to a processing parameter, and that detects a change in electrostatic capacitance;

a physical operator that is arranged on the display surface, and that changes the electrostatic capacitance detected by the touch panel in response to being operated by a user;

a control unit that changes the processing parameter in response to a change in the electrostatic capacitance based on the operation of the physical operator; and

a function selection unit that, in response to an input to the touch panel accompanying a change in the electrostatic capacitance via an operation of the physical operator, selects a type of processing parameter and an icon corresponding to the processing parameter,

wherein the physical operator receives a user operation corresponding to the processing parameter selected by the function selection unit.

### (Item 5)

The processing device according to item 4,

wherein the physical operator comprises a light transmitting portion that transmits light, and

wherein the icon that is displayed in a region overlapping the physical operator is visible through the light transmitting portion.

### (Item 6)

The processing device according to item 4 or 5, wherein the display surface has a first region in which the physical operator is arranged, and a second region in which the physical operator is not arranged.

### (Item 7)

The processing device according to item 6,

wherein the physical operator is one of: a push switch that allows a push operation; an encoder that allows a rotation operation; and a fader that allows a linear movement operation, and

wherein, in a case where the physical operator is the push switch, the first region detects contact by a user's finger with the push switch, and pushing of the push switch, through a change in the electrostatic capacitance,

wherein, in a case where the physical operator is the encoder, the first region detects a rotation operation of the encoder through a change in the electrostatic capacitance, and

wherein, in a case where the physical operator is the fader, the first region detects a linear movement operation of the fader through a change in the electrostatic capacitance, and

wherein the second region detects contact by a user's finger with respect to the second region through a change in the electrostatic capacitance.

### (Item 8)

The processing device according to item 6 or 7, wherein a mechanism that detects a change in the electrostatic capacitance is the same in the first region and the second region.

### (Item 9)

The processing device according to any one of items 6 to 8, wherein a sensitivity with which a change in the electrostatic capacitance is detected in the first region is higher than a sensitivity with which a change in the electrostatic capacitance is detected in the second region.

### (Item 10)

The processing device according to any one of items 6 to9, wherein the first region detects the electrostatic capacitance at a plurality of levels.

### (Item 11)

The processing device according to any one of items 4 to 10, comprising

a support body that integrally supports a plurality of the physical operators.

### (Item 12)

The processing device according to any one of items 4 to 11, wherein a plurality of the physical operators are joined.

### (Item 13)

The processing device according to any one of items 4 to 12, wherein the physical operator can be freely attached to, and detached from, the display surface.

### (Item 14)

The processing device according to any one of items 4 to 13, wherein the control unit changes the processing parameter as a result of a user's finger sliding so as to sequentially make contact with a plurality of the physical operators.

### (Item 15)

The processing device according to any one of items 4 to 14,

wherein the physical operator is a push switch that allows a push operation, and

wherein the touch panel detects contact by a user's finger with the push switch and pushing of the push switch through a change in the electrostatic capacitance.

### (Item 16)

The processing device according to item 15,

wherein the push switch comprises a key top, a support portion placed on the display surface, and a joint portion that joins the key top and the support portion,

wherein the joint portion holds the key top such that the key top is arranged with a spacing from the display surface, and is elastically deformed when the key top is pushed by a user's finger and moves toward the display surface, and

wherein a top surface of the key top with which a user's finger makes contact is recessed in a concave shape.

### (Item 17)

The processing device according to item 15 or 16, wherein the push switch comprises a switch body, and a conductive layer that is coated on a surface of the switch body.

### (Item 18)

The processing device according to any one of items 4 to 14,

wherein the physical operator is an encoder that allows a rotation operation, and

wherein the touch panel detects a rotation operation of the encoder through a change in the electrostatic capacitance.

### (Item 19)

The processing device according to item 18, wherein the touch panel detects both contact by a user's finger with respect to the encoder and a rotation operation of the encoder through a change in the electrostatic capacitance.

### (Item 20)

The processing device according to item 18 or 19, wherein the encoder comprises a cylinder-shaped rotation operation portion that is subjected to a rotation operation by a user's finger, and a push operation portion that is arranged on an inner side of the rotation operation portion and is subjected to a push operation by a user's finger.

### (Item 21)

The processing device according to any one of items 18 to 20, wherein the encoder comprises a fixed portion that is fixed to the touch panel, a rotation operation portion that allows a rotation operation relative to the fixed portion, and a bearing provided between the fixed portion and the rotation operation portion.

### (Item 22)

The processing device according to any one of items 4 to 14,

wherein the physical operator is a fader that allows a linear movement operation, and

wherein the touch panel detects a linear movement operation of the fader through a change in the electrostatic capacitance.

### (Item 23)

The processing device according to item 22, wherein the fader comprises:

a knob portion that is operated by a user's finger; and

a cover portion that is arranged on the display surface and has a guide groove, wherein the guide groove is formed in a linearly extending groove shape and guides the knob portion in a linear direction.

### (Item 24)

The processing device according to item 22 or 23,

wherein the fader comprises a knob portion that is held by a user's finger and is linearly moved, and

wherein the touch panel detects contact by a user's finger with respect to the knob portion, pushing of the knob portion, and linear movement of the knob portion through a change in the electrostatic capacitance.

### (Item 25)

The processing device according to any one of items 4 to 24,

wherein the physical operator is configured such that the icon displayed on the display surface is visible therethrough, and

wherein the function selection unit changes the icon in response to a change in the processing parameter based on an operation of the physical operator.

### (Item 26)

The processing device according to item 25,

wherein the physical operator is either a push switch that allows a push operation, or an encoder that allows a rotation operation, and

wherein, in a case where the physical operator is the push switch, the push switch is configured such that the icon displayed on the display surface is visible therethrough, and

wherein, in a case where the physical operator is the encoder, the encoder comprises a cylinder-shaped rotation operation portion that is subjected to a rotation operation by a user's finger, and an inner portion that is arranged on an inner side of the rotation operation portion, and the inner portion is formed such that the icon displayed on the display surface is visible therethrough.

What is claimed is:

1. An audio and video processing device comprising:
a channel configured to receive input of a signal related to at least one of audio and video;
a processor configured to change a processing parameter corresponding to the signal;
a touch panel that has a display surface that is configured to display an icon corresponding to the channel and related to the processing parameter, and to detect a change in electrostatic capacitance accompanying a user operation; and
a physical operator that is arranged on the display surface, and that is configured to change the electrostatic capacitance detected by the touch panel in response to being operated by a user,
wherein the processor is further configured to:
in response to an input to the touch panel accompanying a change in the electrostatic capacitance via the operation of the physical operator, select a type of processing parameter and the icon corresponding to the processing parameter; and
change the processing parameter in accordance with the change in the electrostatic capacitance based on the operation of the physical operator, and
wherein the physical operator receives a user operation corresponding to the processing parameter selected by the processor.

2. The audio and video processing device according to claim 1,
wherein the channel comprises a plurality of channels, and
wherein the physical operator comprises a collectively corresponding operator that corresponds to the plurality of channels.

3. The audio and video processing device according to claim 2,
wherein the display surface has a first region in which the physical operator is arranged, and a second region in which the physical operator is not arranged, and
the second region displays information related to the channel that has been selected in response to an input to the touch panel.

4. A processing device comprising:
a touch panel that has a display surface that is configured to display an icon related to a processing parameter, and detect a change in electrostatic capacitance;
a physical operator that is arranged on the display surface, and that is configured to change the electrostatic capacitance detected by the touch panel in response to being operated by a user;
a processor that is configured to:
change the processing parameter in response to a change in the electrostatic capacitance based on the operation of the physical operator; and
in response to an input to the touch panel accompanying a change in the electrostatic capacitance via an operation of the physical operator, select a type of processing parameter and an icon corresponding to the processing parameter,
wherein the physical operator receives a user operation corresponding to the processing parameter selected by the processor.

5. The processing device according to claim 4,
wherein the physical operator comprises a light transmitting portion that transmits light, and
wherein the icon that is displayed in a region overlapping the physical operator is visible through the light transmitting portion.

6. The processing device according to claim 4, wherein the display surface has a first region in which the physical operator is arranged, and a second region in which the physical operator is not arranged.

7. The processing device according to claim 6,
wherein the physical operator is one of:
a push switch that allows a push operation;
an encoder that allows a rotation operation; or
a fader that allows a linear movement operation, and
wherein, in a case where the physical operator is the push switch, the first region detects contact by a user's finger with the push switch, and pushing of the push switch, through a change in the electrostatic capacitance,
wherein, in a case where the physical operator is the encoder, the first region detects a rotation operation of the encoder through a change in the electrostatic capacitance, and
wherein, in a case where the physical operator is the fader, the first region detects a linear movement operation of the fader through a change in the electrostatic capacitance, and
wherein the second region detects contact by a user's finger with respect to the second region through a change in the electrostatic capacitance.

8. The processing device according to claim 6, wherein a mechanism that is configured to detect a change in the electrostatic capacitance is the same in the first region and the second region.

9. The processing device according to claim 6, wherein a sensitivity with which a change in the electrostatic capacitance is detected in the first region is higher than a sensitivity with which a change in the electrostatic capacitance is detected in the second region.

10. The processing device according to claim 6, wherein the first region is configured to detect the electrostatic capacitance at a plurality of levels.

11. The processing device according to claim 4, comprising:
a support body that integrally supports a plurality of the physical operators.

12. The processing device according to claim 4, wherein a plurality of the physical operators are joined.

13. The processing device according to claim 4, wherein the physical operator is configured to be freely attached to, and detached from, the display surface.

14. The processing device according to claim 4, wherein the processor is configured to change the processing parameter as a result of a user's finger sliding so as to sequentially make contact with a plurality of the physical operators.

15. The processing device according to claim 4,
wherein the physical operator is a push switch that allows a push operation, and
wherein the touch panel is configured to detect contact by a user's finger with the push switch and pushing of the push switch through a change in the electrostatic capacitance.

16. The processing device according to claim 15,
wherein the push switch comprises a key top, a support portion placed on the display surface, and a joint portion that joins the key top and the support portion,
wherein the joint portion holds the key top such that the key top is arranged with a spacing from the display surface, and is elastically deformed when the key top is pushed by a user's finger and moves toward the display surface, and
wherein a top surface of the key top with which a user's finger makes contact is recessed in a concave shape.

17. The processing device according to claim 15, wherein the push switch comprises a switch body, and a conductive layer that is coated on a surface of the switch body.

18. The processing device according to claim 4,
wherein the physical operator is an encoder that allows a rotation operation, and
wherein the touch panel is configured to detect a rotation operation of the encoder through a change in the electrostatic capacitance.

19. The processing device according to claim 18, wherein the touch panel is configured to detect both contact by a user's finger with respect to the encoder and a rotation operation of the encoder through a change in the electrostatic capacitance.

20. The processing device according to claim 18, wherein the encoder comprises a cylinder-shaped rotation operation portion that is configured to be subjected to a rotation operation by a user's finger, and a push operation portion that is arranged on an inner side of the rotation operation portion and is configured to be subjected to a push operation by a user's finger.

21. The processing device according to claim 18, wherein the encoder comprises a fixed portion that is fixed to the touch panel, a rotation operation portion that allows a rotation operation relative to the fixed portion, and a bearing provided between the fixed portion and the rotation operation portion.

22. The processing device according to claim 4,
wherein the physical operator is a fader configured to allow a linear movement operation, and
wherein the touch panel is configured to detect a linear movement operation of the fader through a change in the electrostatic capacitance.

23. The processing device according to claim 22, wherein the fader comprises:
a knob portion that is configured to be operated by a user's finger; and
a cover portion that is arranged on the display surface and has a guide groove, wherein the guide groove is formed in a linearly extending groove shape and is configured to guide the knob portion in a linear direction.

24. The processing device according to claim 22,
wherein the fader comprises a knob portion that is configured to be held by a user's finger and is configured to be linearly moved, and
wherein the touch panel is configured to detect contact by a user's finger with respect to the knob portion, pushing of the knob portion, and linear movement of the knob portion through a change in the electrostatic capacitance.

25. The processing device according to claim 4,
wherein the physical operator is configured such that the icon displayed on the display surface is visible therethrough, and
wherein the processor is configured to change the icon in response to a change in the processing parameter based on an operation of the physical operator.

26. The processing device according to claim 25,
wherein the physical operator is either a push switch configured to allow a push operation, or an encoder configured to allow a rotation operation,
wherein, in a case where the physical operator is the push switch, the push switch is configured such that the icon displayed on the display surface is visible therethrough, and
wherein, in a case where the physical operator is the encoder, the encoder comprises a cylinder-shaped rotation operation portion that is configured to be subjected to a rotation operation by a user's finger, and an inner portion that is arranged on an inner side of the rotation operation portion, and the inner portion is formed such that the icon displayed on the display surface is visible therethrough.
